(19) United States
(12) Patent Application Publication
(10) Pub. No.: US 2026/0180035 A1
(43) Pub. Date: Jun. 25, 2026

(54) LIFE CYCLE ASSESSMENT-BASED BATTERY MANAGEMENT METHOD, SERVER USING METHOD, AND COMPUTER PROGRAM

(71) Applicants: Won Kug KIM, Andong-si (KR); Jin Kyo SHIN, Seongnam-si (KR); Sung Won PARK, Seoul (KR); ANDANTE CO., LTD., Seongnam-si (KR)

(72) Inventors: Won Kug KIM, Andong-si (KR); Jin Kyo SHIN, Seongnam-si (KR); Sung Won PARK, Seoul (KR); Yeong Ju JEONG, Seoul (KR)

(73) Assignees: Won Kug KIM, Andong-si (KR); Jin Kyo SHIN, Seongnam-si (KR); Sung Won PARK, Seoul (KR); ANDANTE CO., LTD., Seongnam-si (KR)

(21) Appl. No.: 18/713,050

(22) PCT Filed: Nov. 23, 2022
(86) PCT No.: PCT/KR2022/018543

§ 371 Date: May 23, 2024

(30) Foreign Application Priority Data
Nov. 23, 2021 (KR) 10-2021-0161936

(51) Int. Cl. H01M 10/42; H01M 10/48; H01M 50/213

(52) U.S. Cl. CPC H01M 10/4207; H01M 10/482; H01M 50/213; H01M 2220/20

(57) ABSTRACT

Provided is an operating method of a server that performs a life-cycle assessment on a battery. The operating method of the server includes, in a battery pack manufacturing operation, receiving identification information of a battery pack from a battery pack manufacturer, in an operation of mounting the battery pack on a device, receiving device identification information about the device on which the battery pack is mounted and the identification information of a battery pack, from a device manufacturer, mapping the identification information of a battery pack to the device identification information, in the operating operation of the device, receiving user identification information about a user of the device and the device identification information, from a user, and mapping the user identification information to the device identification information, receiving battery data information generated during driving of the device and device data information from the device and analyzing the received information, generating evaluation information for the battery pack according to an analysis result and storing the generated information in the database. The evaluation information for the battery pack includes remaining life and whether to recycle of each of battery cells included in the battery pack.

### TECHNICAL FIELD

The present disclosure relates to a life cycle assessment (LCA)-based battery management method, and more particularly, to a method of managing a battery on an LCA basis from the first manufacture of the battery to the disposal thereof, a server for performing the method, and a computer program.

### BACKGROUND ART

As devices using batteries rapidly increase, a question of how to manage the batteries has arisen.

In order to use a battery installed in an electric car while maintaining its own performance for a long time, it is recommended to charge the battery frequently. When a battery is repeatedly discharged and charged, the life of the battery decreases. Thus, the life of the battery is represented by the number of discharges and charges.

There is a physical characteristic such that when the battery is fully discharged and then charged to 100%, the number of charges of the battery is about 1,000 times to 1,500 times, when the battery is used by 50% and then charged to 100%, the number of charges of the battery is about 5,000 times, and furthermore, when the battery is used by 20% and then charged to 100%, the number of charges of the battery further increases.

For a driving distance of a fully charged electric car is 500 km, when 20% of a battery is used, the electric car may drive 100 km. Assuming that an electric car is charged after driving 100 km every day, The electric car can be used for a considerable period of time without replacing the battery. However, this method simply increases the utility of battery use on the physical aspect according to the driving habits of each user who drives an electric car. Accordingly, more effective battery management technology is necessary.

### DESCRIPTION OF EMBODIMENTS

### Technical Problem

It is an objective of the present disclosure to provide a method of performing a life-cycle assessment on a battery from the first manufacture of the battery to the disposal thereof, a computer program for performing the method, and an apparatus for executing the computer program

### Solution to Problem

According to embodiments of the present disclosure, an operating method of a server that performs a life-cycle assessment on a battery includes: in a battery pack manufacturing operation, receiving, by the server, battery pack information including battery pack identification information of a battery pack from a battery pack manufacturer's computing device and storing, by the server, the received information in a database; in an operation of mounting the battery pack on a device, receiving, by the server, the battery pack identification information, and device identification information about the device on which the battery pack is mounted, from a device manufacturer's computing device; one-to-one mapping, by the server, the device identification information received from the device manufacturer's computing device to the battery pack identification information and storing, by the server, the mapped information in the database; in the operating operation of the device, as the battery pack supplies power to the device, receiving, by the server, the device identification information and battery data information about the battery pack from the device; and searching, by the server, the database for the battery pack identification information by using the device identification information received from the device, generating evaluation information for the battery pack by using the battery pack information about the battery pack mapped to the battery pack identification information, and the battery data information, and storing the evaluation information for the battery pack in the database.

According to embodiments of the present disclosure, a method of providing a service of performing a life-cycle assessment on a battery by using a battery management system including a battery pack manufacturer's computing device, a device manufacturer's computing device, and a server includes: in a battery pack manufacturing operation, receiving, by the server, battery pack information including battery pack identification information of a battery pack from a battery pack manufacturer's computing device and storing, by the server, the received information in a database; in an operation of mounting the battery pack on a device, receiving, by the server, the battery pack identification information, and device identification information about the device on which the battery pack is mounted, from a device manufacturer's computing device; one-to-one mapping, by the server, the device identification information received from the device manufacturer's computing device to the battery pack identification information and storing, by the server, the mapped information in the database; in the operating operation of the device, as the battery pack supplies power to the device, receiving, by the server, the device identification information and battery data information about the battery pack from the device; and searching, by the server, the database for the battery pack identification information by using the device identification information received from the device, generating evaluation information for the battery pack by using the battery pack information about the battery pack mapped to the battery pack identification information, and the battery data information, and storing the evaluation information for the battery pack in the database.

According to embodiments of the present disclosure, an operating method of a server that performs a life-cycle assessment on a battery includes: in a battery pack manufacturing operation, receiving, by the server, battery pack information including battery pack identification information about a battery pack, from a battery pack manufacturer's computing device and storing the received information in a database; in an operation of mounting the battery pack on an electric car, receiving, by the server, the battery pack identification information, and electric car identification information about the electric car on which the battery pack is mounted, from an electric car manufacturer's computing device; one-to-one mapping, by the server, the electric car identification information received from the electric car manufacturer's computing device to the battery pack identification information and storing the mapped information in the database; in a driving operation of the electric car, receiving, by the server, user information including user identification information about a user of the electric car, and the electric car identification information, from a user's computing device; one-to-one mapping, by the server, the user identification information received from the user computing device to any one of the battery pack identification information and the electric car identification information and storing the mapped information in the database as the battery pack supplies power to the electric car, receiving, by the server, the electric car identification information and battery data information about the battery pack, from the electric car; and searching, by the server, the database for the battery pack identification information by using the electric car identification information received from the electric car, generating evaluation information for the battery pack by using the battery pack information about the battery pack mapped to the battery pack identification information and the battery data information, and storing the evaluation information for the battery pack in the database.

According to embodiments of the present disclosure, a method of providing a service of performing a life-cycle assessment on a battery by using a battery management system including a battery pack manufacturer's computing device, an electric car manufacturer's computing device, a user computing device, and a server includes, in a battery pack manufacturing operation, receiving, by the server, battery pack information including battery pack identification information about a battery pack, from a battery pack manufacturer's computing device and storing the received information in a database; in an operation of mounting the battery pack on an electric car, receiving, by the server, the battery pack identification information, and electric car identification information about the electric car on which the battery pack is mounted, from an electric car manufacturer's computing device; one-to-one mapping, by the server, the electric car identification information received from the electric car manufacturer's computing device to the battery pack identification information and storing the mapped information in the database; receiving, by the server, user information including user identification information about a user of the electric car, and the electric car identification information, from a user's computing device; one-to-one mapping, by the server, the user identification information received from the user computing device to any one of the battery pack identification information and the electric car identification information and storing the mapped information in the database; in a driving operation of the electric car, as the battery pack supplies power to the electric car, receiving, by the server, the electric car identification information and battery data information about the battery pack, from the electric car; and searching, by the server, the database for the battery pack identification information by using the electric car identification information received from the electric car, generating evaluation information for the battery pack by using the battery pack information about the battery pack mapped to the battery pack identification information, and the battery data information, and storing the evaluation information for the battery pack in the database.

According to embodiments of the present disclosure, a computer program is combined with hardware and may perform an operating method of a server that performs a life-cycle assessment on a battery, and the computer program is stored in a computer-readable storage medium.

When the battery pack includes a plurality of battery cells, the evaluation information for the battery pack includes residual value information of each of the battery cells.

The residual value information includes at least one of remaining life and whether to recycle of each of the battery cells.

### Advantageous Effects of Disclosure

The present disclosure has an effect in that performance evaluation information and operation information of a battery can be automatically generated through a program by using information obtained in an operation in which a battery is manufactured, information obtained in an operation in which the battery is mounted on a device, information obtained in an operation in which the battery mounted on the device is charged, and information obtained in an operation in which the device is used according to a purpose thereof.

The present disclosure has an effect in that, in an operation of disassembling and recycling a battery, whether to recycle the battery can be easily checked by utilizing the performance evaluation information (e.g., remaining life and whether to recycle a battery) of the battery.

### BRIEF DESCRIPTION OF DRAWINGS

In order to more fully understand the drawings cited in the detailed description of the present disclosure, a detailed description of each drawing is provided.

FIG. 1 is a block diagram of a life cycle assessment (LCA)-based battery management system that performs an LCA-based battery management method, according to an embodiment of the present disclosure.

FIG. 2 shows operations performed in the LCA-based battery management system illustrated in FIG. 1.

FIG. 3 illustrates an embodiment of battery management information stored in a database of the LCA-based battery management system illustrated in FIG. 1.

FIG. 4 illustrates an embodiment of battery module information and battery cell information included in battery pack information of FIG. 3.

FIG. 5 illustrates input/output information of a computer program executed in a server of FIG. 1 that generates evaluation information and operation information.

### MODE OF DISCLOSURE

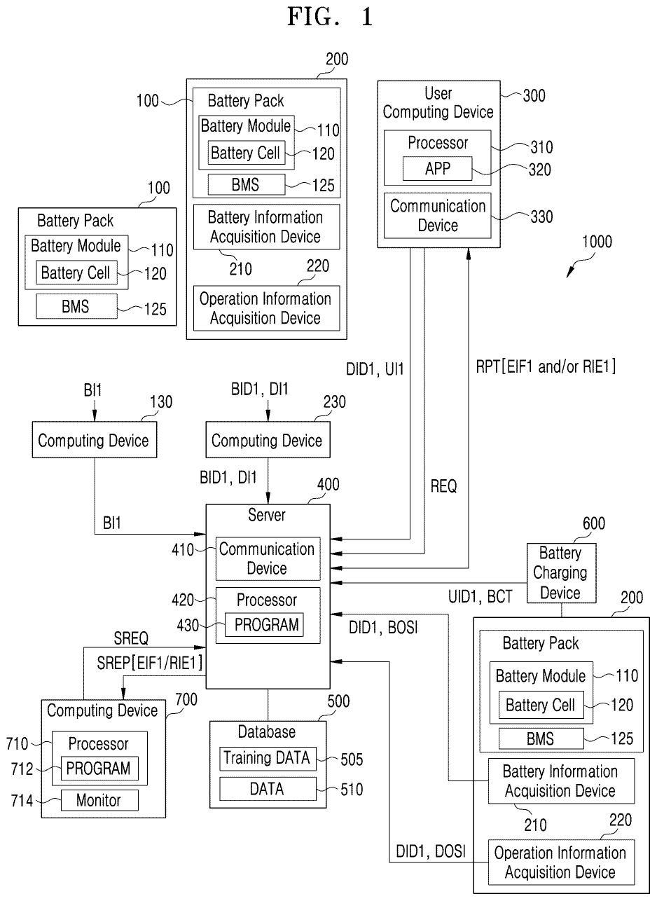

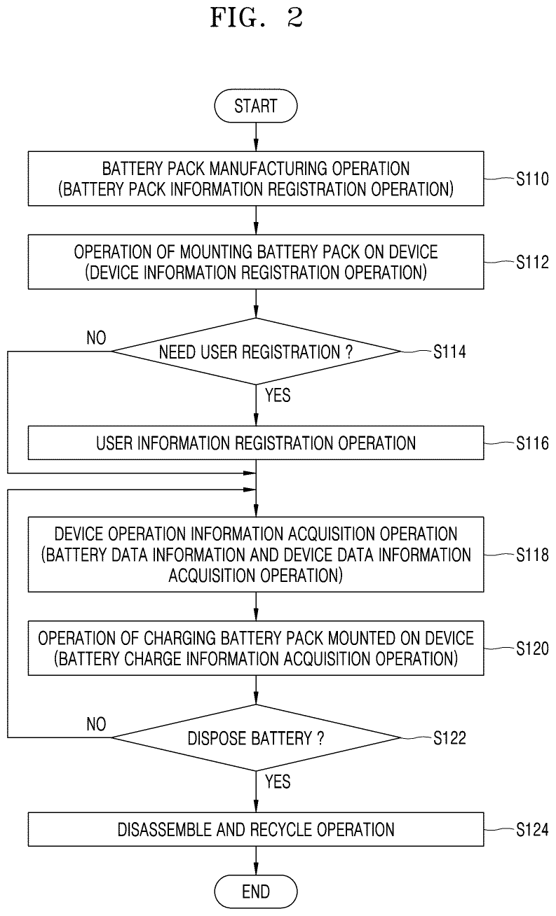

FIG. 1 is a block diagram of a life cycle assessment (LCA)-based battery management system that performs an LCA-based battery management method, according to an embodiment of the present disclosure, and FIG. 2 shows operations performed in the LCA-based battery management system illustrated in FIG. 1.

In the specification, a battery collectively refers to a battery pack, a battery module, and a battery cell. In the specification, although a battery pack 100 is mainly described, the technical concept of the present disclosure is applied not only to the battery pack 100, but also to a battery module 110 included in the battery pack 100 and a battery cell 120 included in the battery module 110, without change. As the number of charges of a battery increases, the life of the battery is reduced.

The LCA-based battery management method refers to a method of managing a life cycle of a battery by using an LCA-based battery management system 1000 from manufacturing a battery (S110) to the disposal of the battery (e.g., disassembling and recycling) (S124), as illustrated in FIG. 2.

The LCA-based battery management method according to the present disclosure increases possibility of recycling of a battery after use, accurately determines (or predicts) a residual value of the battery by using a computer program, and provide information about recycling of a battery (e.g., in units of battery cells) with a high residual value based on a result of the determination (or prediction).

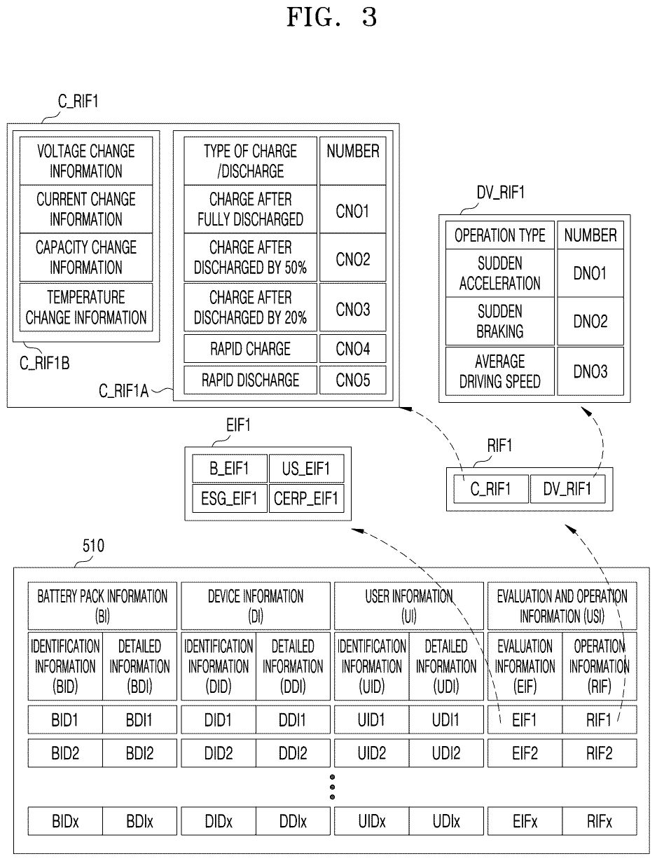

The LCA-based battery management system 1000 may provide evaluation and operation information (USI) to be described with reference to FIG. 3 in units of batteries even at any point of a life cycle from a process of manufacturing a battery until a process of the disposal of the battery through a process of using the battery.

In the specification, examples of the described battery recycling include re-use, recycling, remanufacturing, and refurbishing.

The re-use refers to using a waste battery (e.g., electric car waste battery) by evaluating the state of the waste battery without disassembling the same and repurposing the waste battery to be used for an energy storage system (ESS), an uninterruptible power supply (UPS), or the like.

The recycling refers to disassembling or dismantling a waste battery and then reselling by extracting metal (e.g., lithium, nickel, cobalt, manganese, etc.) and nonferrous metal (e.g., iron scraps, plastic, copper, aluminum, etc.) included in the waste battery.

When a battery performance warranty period has expired or a battery is damaged due to a vehicle accident and the like, the remanufacturing refers to reconstructing the battery to the original specifications, and the refurbishing refers to upgrading the specifications of the battery to the most up-to-date specifications at the time of reconstruction.

Referring to FIG. 1, the LCA-based battery management system 1000 includes the battery pack 100, a first computing device 130, a device 200, a second computing device 230, a server (referred to as a ‘battery management device’ 400), and a battery charging device 600.

According to embodiments, when user information registration for a user using the device 200 is necessary (S114 and S116), the LCA-based battery management system 1000 may further include a user computing device 300. Furthermore, when evaluation information B_EIF1 and the like about the battery pack 100 mounted on the device 200 needs to be transmitted to an external organization (e.g., a vehicle inspection station), an automechanic, a cannibalizer, etc.), the LCA-based battery management system 1000 may further include a third computing device 700.

The respective computing devices 130, 230, 300, and 700 may include personal computers (PCs) or mobile devices that can connect to a communication network, and the mobile devices may include laptop computers, smartphones, or personal digital assistants (PDAs), but the present disclosure is not limited thereto.

In the manufacturing of the battery pack 100 (or a battery pack information registration operation (S110)), when a manager of a manufacturer of the battery pack 100 inputs battery pack information BI1 to the first computing device (e.g., a battery pack manufacturer's computing device 130), the first computing device 130 transmits the battery pack information BI1 to a communication device 410 of the server 400.

The battery pack 100 includes at least one battery module 110 and a battery management system (BMS) 125. The at least one battery module 110 includes one or more battery cells 120.

The BMS 125 controls the operation of each of one or more battery cells 120 included in the battery pack 100 and performs functions to generate related information. For example, these functions include a battery cell management function to manage the battery cells 120 to prevent overload through voltage balancing of the battery cells 120, a state of charge (SOC) prediction function to predict an SOC by sensing a current, a voltage, a temperature, and/or the like of each of the battery cells 120, a power limit function to prevent overcharge and overdischarge of each of the battery cells 120, a diagnosis function to diagnose a failure of the battery pack 100 and the battery cells 120, a cooling control function to cool heat generated in the battery pack 100, and the like.

A battery information acquisition device 210 may generate battery data information BOSI by using information (e.g., a voltage change, a current change, a capacity change, a temperature change, and/or the like) output from the BMS 125.

A computer program 430 executed on a processor 420 of the server 400 receives battery pack information BI about each battery pack from the communication device 410, and stores the battery pack information BI in a database 500. Information DATA stored in the database 500 refers to battery management information.

The computer program 430 may perform the LCA-based battery management method to be described in the specification, in combination with hardware (e.g., the processor 420), and may be stored in a storage medium and then executed by the processor 420. The storage medium may be a memory device that stores the computer program 430, and the memory device may be installed inside the server 400, outside the server 400, or inside the processor 420.

The computer program 430 may be a computer program that can perform an artificial intelligence algorithm or a deep learning algorithm, but the present disclosure is not limited thereto.

The computer program 430 that performs an artificial intelligence algorithm or a deep learning algorithm may be trained with various pieces of information, which are referred to as battery pack information, device information, user information, and evaluation and operation information to be described with reference to FIG. 3, may generate training data 505 corresponding to a training result, and may store the training data 505 in the database 500. For example, the computer program 430 may generate the training data 505 by being trained with battery management information 510.

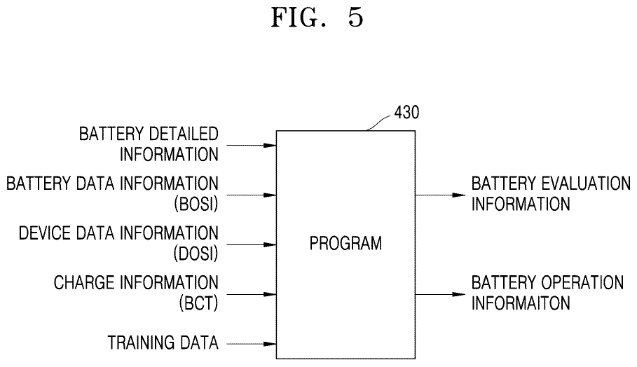

FIG. 5 illustrates input/output information of a computer program executed in a server of FIG. 1 that generates evaluation information and operation information.

According to embodiments, the computer program 430 may generate evaluation information EIF1 about the battery pack 100 by using at least one of the training data 505, device data information DOSI transmitted from the device 200, charge information BCT transmitted from the battery charging device 600, and battery detailed information (e.g., detailed information about a battery pack, a battery module, and a battery cell), and the battery data information BOSI transmitted from the device 200.

According to embodiments, the computer program 430 may generate at least one of user evaluation information US_EIF1 and device operation information DV_RIF1 by using the device data information DOSI transmitted from the device 200. The computer program 430 may generate at least one of charge data information C_RIF1A and battery operation data information C_RIF1B by using the charge information BCT transmitted from the battery charging device 600. The computer program 430 may generate at least one of charge data information C_RIF1A, the battery operation data information C_RIF1B, and the evaluation information B_EIF1 about the battery pack 100 by using the battery data information BOSI transmitted from the device 200.

The computer program 430 may generate the evaluation information EIF1 about the battery pack 100 by using the battery data information BOSI. The computer program 430 may generate operation information RIF1 about the battery pack 100 by using at least one of the battery data information BOSI, the device data information DOSI, and the charge information BCT.

FIG. 3 illustrates an embodiment of battery management information stored in a database of the LCA-based battery management system illustrated in FIG. 1.

Referring to FIGS. 1 to 3, first battery pack information (referred to as ‘BI1’) about a first battery pack includes first battery pack identification information BID1 and first battery pack detailed information BDI1, second battery pack information (referred to as ‘BI2’) about a second battery pack include second battery pack identification information BID2 and second battery pack detailed information BDI2, and x-th battery pack information (referred to as ‘BIx’) about an x-th battery pack includes x-th battery pack identification information BIDx and x-th battery pack detailed information BDIx.

First device information (referred to as ‘DI1’) about a first device that is one-to-one mapped to the first battery pack includes first device identification information DID1 and first device detailed information DDI1, second device information (referred to as ‘DI2’) about a second device that is one-to-one mapped to the second battery pack includes second device identification information DID2 and second device detailed information DDI2, and x-th device information (referred to as ‘DIx’) about an x-th device that is one-to-one mapped to the x-th battery pack includes x-th device identification information DIDx and x-th device detailed information DDIx.

First user information (referred to as ‘UI1’) about a first user that is one-to-one mapped to the first device includes first user identification information UID1 and first user detailed information UDI1, second user information (referred to as ‘UI2’) about a second user that is one-to-one mapped to the second device include second user identification information UID2 and second user detailed information UDI2, and x-th user information (referred to as ‘UIx’) about an x-th user that is one-to-one mapped to the x-th device includes x-th user identification information UIDx and x-th user detailed information UDIx.

First evaluation and operation information (referred to as ‘USI1’) that is mapped to any one of the first battery pack 100, the first device 200, and the first user includes the first evaluation information EIF1 and the first operation information RIF1. Each of the first evaluation information EIF1 and the first operation information RIF1 includes evaluation information and operation information for each battery module, and evaluation information and operation information for each battery cell.

The first evaluation information EIF1 generated by the computer program 430 includes the following evaluation information.
1. The evaluation information B_EIF1 about the first battery pack 100,
2. The first user evaluation information US_EIF1 using the first device 200,
3. Environmental, social, and governance structure (ESG) evaluation information ESG_EIF1 of a company about any one of a manufacturer manufacturing the first battery pack 100, a manufacturer manufacturing the first device 200, and the first user using the first device 200 by using the evaluation information B_EIF1, and
4. Certificated emissions reduction CER information CERP_EIF1 about any one of the manufacturer manufacturing the first battery pack 100, the manufacturer manufacturing the first device 200, and the first user using the first device 200 by using the evaluation information B_EIF1.

The first operation information RIF1 generated by the computer program 430 includes the following evaluation information. The first operation information RIF1 includes battery pack operation information C_RIF1 and device operation information DV_RIF1.
i. The battery pack operation information C_RIF1 including the charge data information C_RIF1A and the battery operation data information C_RIF1B, and
ii. The device operation information DV_RIF1 generated by using the device data information DOSI.

The charge data information C_RIF1A includes the following number of charge/discharge according to types.
(1) An accumulated number whenever the first battery pack 100 is fully discharged and then charged to 100% (CNO1),
(2) An accumulated number whenever the first battery pack 100 is discharged by 50% and then charged to 100% (CNO2),
(3) An accumulated number whenever the first battery pack 100 is discharged by 20% and then charged to 100% (CNO3),
(4) An accumulated number whenever the first battery pack 100 is rapidly charged (CNO4), and
(5) An accumulated number whenever the first battery pack 100 is discharged and charged (CNO5),

The battery operation data information C_RIF1B includes the following information.
(I) The voltage change information of the first battery pack 100,
(II The voltage change information of the first battery pack 100,
(III) The capacity change information of the first battery pack 100, and
(IV) The temperature change information of the first battery pack 100.

Second evaluation and operation information (referred to as ‘USI2’) that is mapped to any one of the second battery pack, the second device, and the second user includes second evaluation information EIF2 and second operation information RIF2.

Except that an evaluation target is changed from the first battery pack 100 to the second battery pack, the second evaluation and operation information USI2 is almost the same as the first evaluation and operation information USI1 described above.

Except that an evaluation target is changed from the first battery pack 100 to the x-th battery pack, x-th evaluation and operation information USIx is almost the same as the first evaluation and operation information USI1 described above.

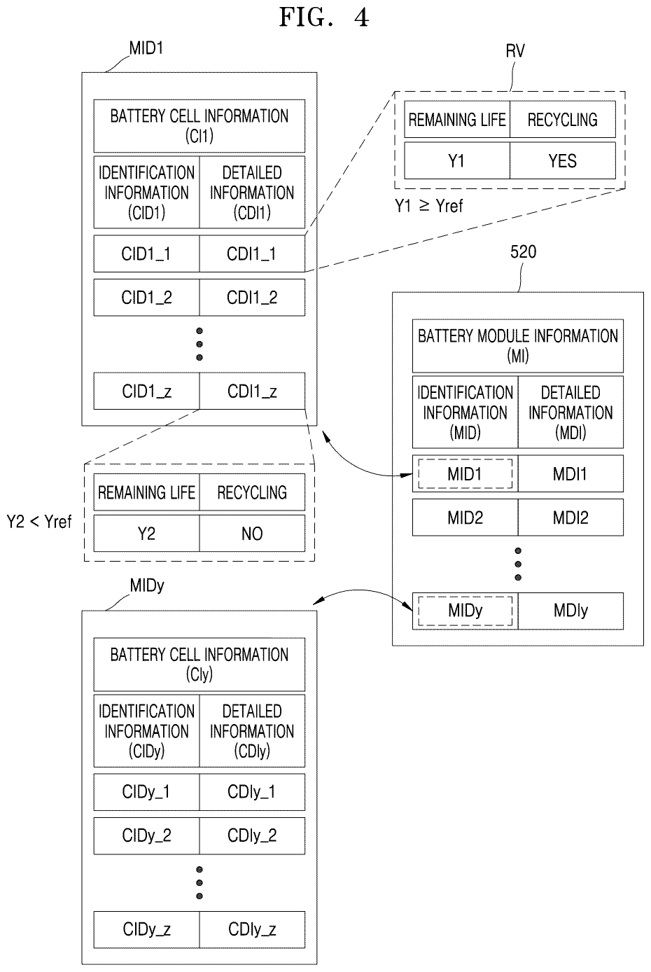

FIG. 4 illustrates an embodiment of battery module information and battery cell information included in battery pack information of FIG. 3.

It is assumed that the battery pack 100 illustrated in FIG. 1 includes y battery modules 110, and each of the y battery modules 110 includes z battery cells 120. Here, each of y and z is a natural number greater than or equal to 2.

The first battery pack information BI1 includes battery module information 520 or MI about the y battery modules 110, first battery module information (referred to as ‘MI1’) includes first battery module identification information MID1 and first battery module detailed information MDI1 of a first battery module, second battery module information (referred to as ‘MI2’) includes second battery module identification information MID2 and second battery module detailed information MDI2 of a second battery module, and y-th battery module information (referred to as ‘MIy’) includes y-th battery module identification information MIDy and y-th battery module detailed information MDIy of a y-th battery module.

The first battery module information MI1 includes battery cell information CI1 about the z battery cells 120, first battery cell information CI1_1 includes first battery cell identification information CID1_1 and first battery cell detailed information CDI1_1 about a first battery cell, second battery cell information CI1_2 includes second battery cell identification information CID1_2 and second battery cell detailed information CDI1_2 about a second battery cell, and z-th battery cell information CI1_z includes z-th battery cell identification information CID1_z and z-th battery cell detailed information CDI1_z about a z-th battery cell.

The first battery cell detailed information CDI1_1 of the first battery module includes residual value information RV about the first battery cell, and the residual value information RV includes a remaining life Y1 of the first battery cell and recycling YES of the first battery cell.

At least one of the remaining life Y1 and the recycling YES may be predicted (or calculated) by the computer program 430 based on at least one of a state of health (SOH), the charge data information C_RIF1A, and the battery operation data information C_RIF1B of the first battery cell.

According to an embodiment, the computer program 430 may calculate the remaining life Y1 by using at least one of the state of health SOH, the charge data information C_RIF1A, and the battery operation data information C_RIF1B of the first battery cell, and a performance warranty period of the first battery cell.

For example, when the remaining life Y1 of the first battery cell is greater than or equal to a reference remaining life Yref, the computer program 430 may be determined (or predicted) that the first battery cell can be recycled (YES).

Z-th battery cell detailed information CDI1_z of the first battery module includes residual value information about the z-th battery cell, and the residual value information includes a remaining life Y2 of the z-th battery cell and recycling NO of the z-th battery cell. At least one of the remaining life Y2 and the recycling NO may be predicted by the computer program 430 based on at least one of the state of health SOH, the charge data information C_RIF1A, and the battery operation data information C_RIF1B of the z-th battery cell.

For example, when the remaining life Y2 of the z-th battery cell is less more than the reference remaining life Yref, the computer program 430 may determine (or predict) that recycling of the z-th battery cell is impossible (NO). The reference remaining life Yref may be a performance warranty period of a corresponding battery cell.

For example, the computer program 430 predicts corresponding remaining lives Y1 and Y2 to be short when the charge number after full discharge (CNO1) and the rapid charge number (CNO4) of a corresponding battery cell increase, and to be long when the charge number after 20% discharge (CNO3) and the average driving speed (DNO3) of a corresponding battery cell are a recommended driving speed.

When the remaining lives Y1 and Y2 of a corresponding battery cell are predicted to be long, the recycling of the corresponding battery cell may be predicted to be possible (YES).

The computer program 430 may predict a maximum remaining life and a minimum remaining life. Each of the remaining lives Y1 and Y2 may be any one of the maximum remaining life and the minimum remaining life. The computer program 430 may select the maximum remaining life or the minimum remaining life as each of the remaining lives Y1 and Y2 according to a value (or program code) set by a manager of the server 400.

Y-th battery module information MIy includes battery cell information CIy about the z battery cells 120, first battery cell information CIy_1 includes first battery cell identification information CIDy_1 and first battery cell detailed information CDIy_1 of the first battery cell, second battery cell information CIy_2 includes second battery cell identification information CIDy_2 and second battery cell detailed information CDIy_2 of the second battery cell, and z-th battery cell information CIy_z includes z-th battery cell identification information CIDy_z and z-th battery cell detailed information CDIy_z of the z-th battery cell.

The identification information BID1 to BIDz, MID1 to MIDy, CID1_1 to CID1_z, and CIDy_1 to CIDy_z about the corresponding batteries 100, 110, and 120 may be identification information, by which the corresponding batteries 100, 110, and 120 can be uniquely identified, and a manufacture's serial number given by a manufacturer of the corresponding batteries 100, 110, and 120, but the present disclosure is not limited thereto.

The detailed information BDI1 to BDIx, MDI1 to MDIy, CDI1_1 to CDI1_z, and CDIy_1 to CDIy_z about the corresponding batteries 100, 110, and 120 include a specification provided by a manufacturer of the corresponding batteries 100, 110, and 120, for example, a manufacturer and date of manufacture of the corresponding batteries 100, 110, and 120, or a type (e.g., a lithium ion battery), a capacity (Ah), an energy capacity (kWh), an operating voltage (V), an operating temperature (° C.), charge/discharge cycles, a performance warranty period, a charging time (e.g., slow charging time and/or rapid charging time), and the like of a corresponding battery.

The detailed information BDI1 to BDIx about a corresponding battery pack may further include the number of battery modules included in the corresponding battery pack, the number of battery cells included in the battery module, and the like, but the present disclosure is not limited thereto.

The detailed information MDI1 to MDIy about a corresponding battery module may further include the number of battery cells included in the corresponding battery module, and the like, but the present disclosure is not limited thereto.

Hereinafter, for convenience of explanation, it is assumed that the battery pack 100 is mounted on the device 200 and a purchaser of the device 200 is a user of the device 200.

The server 400 may receive sample battery information about each of sample batteries (e.g., information similar to the battery management information 510 stored in the database 500 of FIG. 1), train the sample battery information by using an artificial intelligence algorithm or a deep learning algorithm, generate the training data 505 based on the training, and store the training data 505 in the database 500. The training data 505 may be bigdata.

In a battery pack manufacturing operation (or a battery pack information registration operation (S110)), when a manager of a manufacturer manufacturing the battery pack 100 inputs the battery pack information BI1 including the battery pack identification information BID1 and the battery pack detailed information BDI1 of the battery pack 100 to a battery pack manufacturer's computing device 130, a/the computer program 530 executed on the processor 420 of the server 400 receives the battery pack information BI1 through the communication device 410, and stores the battery pack information BI1 in the database 500 as data 510.

In an operation of mounting the battery pack 100 on the device 200 (or a device information registration operation) (S112), when a manager of a manufacturer manufacturing the device 200 input device information DI1 including the device identification information DID1 and the device detailed information DDI1, and the battery pack identification information BID1 to a device manufacturer's computing device 230, the computer program 530 may receive the battery pack identification information BID1 and the device information DI1 through the communication device 410.

The device 200 mounted with battery pack 100 may be an electric vehicle (a battery car, an electric automobile, or an electric car), an energy storage system (ESS), or an uninterruptible power supply (UPS), but the present disclosure is not limited thereto.

The device 200 includes the battery pack 100, the battery information acquisition device 210, and an operation information acquisition device 220.

The battery information acquisition device 210 generates the battery data information BOSI about the battery pack 100 by using information (e.g., voltage change information, current change information, capacity change information, etc.) output from the BMS 125 of the battery pack 100, and transmits the same to the communication device 410 of the server 400.

The operation information acquisition device 220 generates the device data information DOSI about the device 200 generated during the operation of the device 200 and transmit the same to the communication device 410 of the server 400. The device data information DOSI includes the number of sudden accelerations, the number of sudden braking, an average driving speed, and the like for a certain period of time.

The device identification information DID1 may be information that can uniquely identify the device 200, and may include a manufacture's serial number. For example, when the device 200 is an electric car, the device identification information DID may be a vehicle identification number.

The device detailed information DDI1 includes manufacturer, date of manufacture, and the like of the device 200.

The computer program 530 extracts the device identification information DID1 from the device information DI1 transmitted from the device manufacturer's computing device 230, one-to-one maps the device identification information DID1 to the battery pack identification information BID1, and stores a mapping result in the database 500 as the battery management information 510.

When a user registration is not needed (NO in S114), in a device operation information acquisition operation (e.g., a battery data information and device data information acquisition operation (S118)), as the battery pack 100 supplies power (e.g., a voltage or current) to the device 200, the computer program 530 receives the battery data information BOSI about the battery pack 100 and the device identification information DID1 from the device 200 through the communication device 410.

The computer program 530 searches, by using the device identification information DID1 transmitted from the device 200, the database 500 for the battery pack identification information BID1 that is one-to-one mapped to the device identification information DID1, generates the evaluation information B_EIF1 about the battery pack 100 by using the battery pack information BI1 and the battery data information BOSI about the battery pack 100 mapped with the battery pack identification information BID1, and store the same in the database 500 as the battery management information 510.

When the battery pack 100 includes the battery cells 120, the evaluation information B_EIF1 about the battery pack 100 includes the residual value information RV of each of the battery cells 120. As described with reference to FIG. 3, the residual value information RV includes at least one of the remaining life and whether to recycle of each of the battery cells 120.

As the battery pack 100 supplies power (e.g., a voltage or current) to the device 200, the computer program 530 receives the device data information DOSI and the device identification information DID1 generated from the device 200 from the device 200 through the communication device 410.

The computer program 530 generates the device operation information DV_RIF1 by using the device data information DOSI. The device operation information DV_RIF1 includes a sudden acceleration number DNO1, a sudden braking number DNO2, and an average driving speed DNO3.

The computer program 530 searches, by using the device identification information DID1 transmitted from the device 200, the database 500 for the battery pack identification information BID1 that is one-to-one mapped to the device identification information DID1, generates the evaluation information B_EIF1 about the battery pack 100 and/or the user evaluation information US_EIF1 by using the battery pack information Bl1 about the battery pack 100 mapped to the battery pack identification information BID1 and the device data information DOSI, and store the same in the database 500 as the battery management information 510.

The battery pack 100 mounted on the device 200 is used until the battery pack 100 becomes a disposal target.

When the battery pack 100 is a disposal target (YES in S122), in the operation of disassembling and recycling the battery pack 100 (S124), when a user of the third computing device 700 inputs the battery pack identification information BID1 or the device identification information DID1 to a computer program 712 that is executed on a processor 710, the computer program 712 generates evaluation information transmission request SREQ including the battery pack identification information BID1 or the device identification information DID1 and transmits the same to the communication device 410 of the server 400.

The computer program 530 receives the evaluation information transmission request SREQ from the communication device 410, searches the database 500 for the evaluation information B_EIF1 about the battery pack 100 by using the battery pack identification information BID1 or the device identification information DID1 included in the evaluation information transmission request SREQ, generates first report information SREP including the evaluation information B_EIF1, and transmits the same to the third computing device 700 through the communication device 410.

According to an embodiment, the computer program 530 may generate the first report information SREP including at least a portion of the evaluation information EIF1 and/or at least a portion of the operation information RIF1 and transmit to the third computing device 700 through the communication device 410.

The computer program 712 of the third computing device 700 transmits, to a monitor 714, the evaluation information B_EIF1 about the battery pack 100, at least a portion of the evaluation information EIF1, and/or at least a portion of the operation information RIF1 included in the first report information SREP. A user of the third computing device 700 may check a residual value of each of the battery cells 120 included in the evaluation information B_EIF1.

In the method of providing a service of performing a life-cycle assessment on the battery pack 100 by using the LCA-based battery management system 1000 including the battery pack manufacturer's computing device 130, the device manufacturer's computing device 230, and the server 400, the server 400 receives the battery pack information BI1 including the battery pack identification information BID1 about the battery pack 100 from the battery pack manufacturer's computing device 130 and stores the same in the database 500.

The server 400 receives the battery pack identification information BID1, and the device identification information DID1 of the device 200 mounted with battery pack 100 from the device manufacturer's computing device 230.

The server 400 one-to-one maps the device identification information DID1 to the battery pack identification information BID1 received from the device manufacturer's computing device 230 and stores the same in the database 500.

The server 400 receives, from the device 200, the device identification information DID1, and the battery data information BOSI generated by the battery pack 100 as the battery pack 100 supplies power to the device 200.

The server 400 searches the database 500 for the battery pack identification information BID1 by using the device identification information DID1 received from the device 200, and generates the evaluation information B_EIF1 about the battery pack 100 by using the battery pack information BI1 about the battery pack 100 one-to-one mapped to the battery pack identification information BID1 and the battery data information BISI.

Hereinafter, for convenience of explanation, it is assumed that the battery pack 100 is mounted on an electric car 200, the user of the electric car 200 registers user information by using the user computing device 300, and the user charges the electric car 200 by using the battery charging device 600.

When the manager of a manufacturer of the battery pack 100 inputs the battery pack information BI1 including the battery pack identification information BID1 and the battery pack detailed information BDI1 about the battery pack 100 to the battery pack manufacturer's computing device 130, the computer program 430 receives the battery pack information BI1 through the communication device 410 and stores the battery pack information BI1 in the database 500.

As user registration is necessary (YES in S114), the user information registration operation S116 is performed.

When the manager of the manufacturer of the electric car 200 on which the battery pack 100 is mounted inputs the electric car information DI1 including the electric car identification information DID1 and the electric car detailed information DDI1 about the electric car 200 to the electric car manufacturer's computing device 230, the computer program 430 receives the electric car information DI1, extracts the electric car identification information DID1 from the electric car information DI1, one-to-one maps the electric car identification information DID1 to the battery pack identification information BID1, and stores the electric car information DI1 in the database 500.

When the user of the electric car 200 inputs the user information UI1 including the user identification information UID1 and the user detailed information UID1, and the electric car identification information DID1, to an application 320 executed on a processor 310 of the user computing device 300, the application 320 transmits the user information Ul1 and the electric car identification information DID1 to the communication device 410 of the server 400 through a communication device 330.

The computer program 430 receives the user information UI1 and the electric car identification information DID1 through the communication device 410, extracts the user identification information UID1 from the user information UI1, searches the database 500 for the battery pack identification information BID1 by using the electric car identification information DID1, one-to-one maps the user identification information UID1 to the battery pack identification information BID1 or the electric car identification information DID1, and stores the user information UI1 in the database 500.

The user identification information UID1 may include, as information that can uniquely identify a user, an ID set by a user, an electric car registration number, a vehicle driving license number, or the like, and the user detailed information UID1 may include a name, an address, a telephone number, or the like.

When the user information registration operation S116 is completed, the battery pack identification information BID1, the electric car identification information DDI1, and the user identification information UID1 are mapped to one another.

The computer program 430 sequentially performs two times of mapping operations. Among the two times of mapping operations, the first mapping operation is an operation of one-to-one mapping of the battery pack identification information BID1 to the electric car identification information DDI1, and the second mapping operation is an operation of one-to-one mapping of any one of the battery pack identification information BID1 and the electric car identification information DDI1 to the user identification information UID1.

During the driving of the electric car 200 (i.e., when the battery pack 100 supplies power to the electric car 200), the battery information acquisition device 210 receives, in real time, periodically or at each set time, information related to the operation of the battery pack 100 (e.g., voltage change information, current change information, capacity change information, temperature change information, etc.) from the BMS 125 of the battery pack 100, generate the battery data information BOSI by using the received information, and transmit the electric car identification information DDI1 and the battery data information BOSI to the communication device 410 of the server 400.

During the driving of the electric car 200 (i.e., when the battery pack 100 supplies power to the electric car 200), the operation information acquisition device 220 receives, in real time, periodically or at each set time, information related to the operation of the electric car 200 (e.g., a sudden accelerations number, a sudden braking number, an average driving speed, etc.), generates the electric car data information DOSI by using the received information, and transmits the electric car identification information DDI1 and the electric car data information DOSI to the communication device 410 of the server 400.

According to embodiments, the times when the battery data information BOSI and the device data information DOSI are transmitted to the server 400 may be the same or different from each other.

According to embodiments, when the battery information acquisition device 210 and the operation information acquisition device 220 are made in one device, the one device transmits, in real time, periodically or at each set time, the electric car identification information DDI1, the battery data information BOSI, and the device data information DOSI to the communication device 410 of the server 400.

When the computer program 430 receives the electric car identification information DID1 and the battery data information BOSI from the communication device 410, the computer program 430 searches the database 500 for the battery pack identification information BID1 by using the electric car identification information DID1, generates the evaluation information B_FIF1 about the battery pack 100 by using the battery pack information BI1 and the battery data information BOSI about the battery pack 100 one-to-one mapped to the battery pack identification information BID1, and stores the evaluation information B_FIF1 about the battery pack 100 in the database 500.

When the computer program 430 receives the electric car identification information DID1 and the device data information DOSI through the communication device 410, the computer program 430 analyzes the device data information DOSI and generate the user evaluation information US_EIF1 corresponding to an analysis result, searches the database 500 for the battery pack identification information BID1 by using the electric car identification information DID1, and stores the user evaluation information US_EIF1 in an evaluation information field one-to-one mapped to the battery pack identification information BID1.

For example, when the computer program 430 receives the electric car identification information DID1 and the electric car data information DOSI through the communication device 410, the computer program 430 analyzes a driving pattern of a user driving the electric car 200 (e.g., whether the user frequently performs sudden accelerations and sudden braking, performs constant speed driving, etc.) based on the electric car data information DOSI, and generates the user evaluation information US_EIF1 corresponding to an analysis result.

In this state, the computer program 430 may search the database 500 for the battery pack identification information BID1 by using the electric car identification information DID1, and generate (or update) the evaluation information B_EIF1 about the battery pack 100 by using the user evaluation information US_EIF1, the battery data information BOSI, and the battery pack information BI1 about the battery pack 100 one-to-one mapped to the battery pack identification information BID1.

When the user of the electric car 200 inputs a user evaluation information transmission request REQ including the user identification information UID1 to the application 320, the application 320 transmits the user evaluation information transmission request REQ to the communication device 410 of the server 400 through the communication device 330.

The computer program 430 receives the user evaluation information transmission request REQ, extracts the user identification information UID1 from the user evaluation information transmission request REQ, extracts the user evaluation information US_EIF1 from the database 500 by using the user identification information UID1, generates second report information RPT including the user evaluation information US_EIF1, and transmits the second report information RPT to the communication device 330 of the user computing device 300 through the communication device 410.

The application 320 displays the second report information RPT on a monitor of the user computing device 300. The second report information RPT includes a sudden accelerations number, a sudden braking number, an average driving speed, and the like for a specific period, and may include information that increases the life of the battery pack 100.

The computer program 430 generates the second report information RPT including the user evaluation information US_EIF1 and the evaluation information B_EIF1 about the battery pack 100 reflecting the user evaluation information US_EIF1, and transmits the second report information RPT to the communication device 330 of the user computing device 300 through the communication device 410.

In the operation of charging the battery pack 100 mounted on the electric car 200 (or the battery charge information acquisition operation S120), the electric car 200 is connected to the battery charging device 600 to charge the battery pack 100 mounted therein.

The battery charging device 600 transmits the user identification information UID1 and the charge information BCT to the communication device 410 of the server 400. The user identification information UID1 is obtained by the battery charging device 600 in a process in which the user pays a charge fee.

The charge information BCT includes a charge station name, a charge station address, a type of the battery charging device 600, a charge type (e.g., slow charging or rapid charging), a charging time (e.g., a slow charging time or a rapid charging time), a charge amount, and the like.

The type of the battery charging device 600 is classified into a first type battery charging device and a second type battery charging device.

The first type battery charging device supplies power generated by using fossil fuel to the battery pack 100 for charging, and the second type battery charging device supplies power generated by using renewable energy to the battery pack 100 for charging. The renewable energy includes solar energy, biomass, wind power, small hydro power, fuel cells, marine energy, waste energy, geothermal heat, and hydrogen.

The computer program 430 generates at least one of the certificated emissions reduction CER evaluation information CERP_EIF1 and the ESG evaluation information ESG_EIF1 for the user of the electric car 200, according to the type of the battery charging device 600 included in the charge information BCT. For example, the more the electric car 200 is charged by using the second type battery charging device, the better the ESG evaluation information ESG_EIF1 and/or the certificated emissions reduction CER evaluation information CERP_EIF1 may be evaluated.

The computer program 430 receives the user identification information UID1 and the charge information BCT through the communication device 410, and stores the charge information BCT in the charge data information C_RIF1A of the battery pack operation information C_RIF1 included in the operation information RIF1, by using the user identification information UID1.

The charge data information C_RIF1A includes, for each charging, the type of the battery charging device 600, the number (e.g., accumulated number) of charges/discharges for the battery pack 100, a rapid charge number, a rapid discharge number, a charging time for each charge, a charge amount for each charge, and the like.

The computer program 430 searches the database 500 for the battery pack identification information BID1 by using the user identification information UID1 received from the battery charging device 600, and updates the battery pack operation information C_RIF1 according to the charge information BCT.

When the battery pack 100 is not a disposal target (NO in S122), the operations S118 and S120 are continuously performed until the battery pack 100 becomes a disposal target.

When the battery pack 100 is a disposal target (YES in S122), in the operation of disassembling and recycling the battery pack 100 (S124), when the user of the third computing device 700 inputs the battery pack identification information BID1 or the device identification information DID1 to the computer program 712 that is executed on the processor 710, the computer program 712 generates the evaluation information transmission request SREQ including the battery pack identification information BID1 or the device identification information DID1 and transmits the same to the communication device 410 of the server 400.

The computer program 530 receives the evaluation information transmission request SREQ from the communication device 410, searches the database 500 for the evaluation information B_EIF1 about the battery pack 100 by using the battery pack identification information BID1 or the device identification information DID1 included in the evaluation information transmission request SREQ, generates the first report information SREP including the evaluation information B_EIF1, and transmits the same to the third computing device 700 through the communication device 410.

The computer program 712 of the third computing device 700 transmits, to the monitor 714, the evaluation information B_EIF1 about the battery pack 100 included in the first report information SREP. The user of the third computing device 700 may check a residual value for each battery cell 120 included in the evaluation information B_EIF1.

As a person skilled in the art can see, the present disclosure is not limited to the description presented in the present disclosure, but may be modified, reconstructed, and replaced in various ways without departing from the scope of the present disclosure. It may be seen that various technologies described in the present specification may be embodiment by hardware, software, or a combination of hardware and software.

### Industrial Applicability

The present disclosure may be used for a battery management method, a server for performing the method, and a computer program.

1. An operating method of a server that performs a life-cycle assessment on a battery, the operating method comprising:
in a battery pack manufacturing operation, receiving, by the server, battery pack information including battery pack identification information of a battery pack from a battery pack manufacturer's computing device and storing, by the server, the battery pack information in a database;
in an operation of mounting the battery pack on a device, receiving, by the server, the battery pack identification information and device identification information about the device on which the battery pack is mounted, from a device manufacturer's computing device;
one-to-one mapping, by the server, the device identification information to the battery pack identification information received from the device manufacturer's computing device and storing, by the server, the mapped information in the database;
in the operating operation of the device, as the battery pack supplies power to the device, receiving, by the server, the device identification information and battery data information about the battery pack from the device; and
searching, by the server, the database for the battery pack identification information by using the device identification information received from the device, generating, by the server, evaluation information for the battery pack by using the battery data information and the battery pack information about the battery pack mapped to the battery pack identification information, and storing, by the server, the evaluation information for the battery pack in the database.

2. The operating method of claim 1, wherein,
when the battery pack comprises a plurality of battery cells, the evaluation information for the battery pack comprises residual value information of each of the battery cells.

3. The operating method of claim 2, wherein
the residual value information comprises at least one of remaining life and whether to recycle of each of the battery cells.

4. The operating method of claim 1, further comprising receiving, by the server, sample battery information about each of sample batteries, training, by the server, the received sample battery information by using an artificial intelligence algorithm or a deep learning algorithm, and generating training data according to the training,
wherein the generating of the evaluation information for the battery pack comprises analyzing, by the server, the battery information and the battery data information by using the training data, and generating, by the server, the evaluation information for the battery pack according to an analysis result, the server using the artificial intelligence algorithm or the deep learning algorithm.

5. The operating method of claim 1, wherein
the device comprises an electric car, an energy storage system (ESS), or an uninterruptible power supply (UPS).

6. The operating method of claim 1, further comprising:
receiving, by the server, an evaluation information transmission request including the battery pack identification information or the device identification information, from the computing device;
searching, by the server, the database for the evaluation information for the battery pack by using the battery pack identification information or the device identification information included in the evaluation information transmission request; and
transmitting, by the server, the evaluation information for the battery pack to the computing device.

7. The operating method of claim 1, further comprising:
as the battery pack supplies power to the device, receiving, by the server, the device identification information from the device, and receiving, by the server, device data information generated by the device from the device; and
searching, by the server, the database for the battery pack identification information by using the device identification information received from the device, and generating the evaluation information for the battery pack by using the battery pack information about the battery pack mapped to the battery pack identification information, the battery data information, and the device data information.

8. The operating method of claim 1, further comprising
generating, by the server, battery operation data information and charge data information for the battery pack by using the battery data information,
wherein the charge data information comprises a number of charge/discharge according to types for the battery pack, and
the battery operation data information comprises at least one of change information about an output voltage of the battery pack and change information about an output current of the battery pack.

9. A storage medium storing a computer program to perform an operating method of a server that performs a life-cycle assessment on a battery, wherein the computer program performs:
in a battery pack manufacturing operation, receiving battery pack information including battery pack identification information of a battery pack from a battery pack manufacturer's computing device and storing the battery pack information in a database;
in an operation of mounting the battery pack on a device, receiving the battery pack identification information, and device identification information about the device on which the battery pack is mounted, from a device manufacturer's computing device;
one-to-one mapping the device identification information to the battery pack identification information received from the device manufacturer's computing device and storing the mapped information in the database;
in the operating operation of the device, as the battery pack supplies power to the device, receiving the device identification information, and battery data information about the battery pack, from the device; and
searching the database for the battery pack identification information by using the device identification information received from the device, generating evaluation information for the battery pack by using the battery data information and the battery pack information about the battery pack mapped to the battery pack identification information, and storing the evaluation information for the battery pack in the database.

10. A computer program combined with hardware and stored in a storage medium to perform an operating method of a server that performs a life-cycle assessment on a battery,
wherein the computer program stored in the storage medium performs:
in a battery pack manufacturing operation, receiving battery pack information including battery pack identification information of a battery pack from a battery pack manufacturer's computing device and storing the battery pack information in a database;
in an operation of mounting the battery pack on a device, receiving the battery pack identification information, and device identification information about the device on which the battery pack is mounted, from a device manufacturer's computing device;
one-to-one mapping the device identification information to the battery pack identification information received from the device manufacturer's computing device and storing the mapped information in the database;
in the operating operation of the device, as the battery pack supplies power to the device, receiving the device identification information, and battery data information about the battery pack, from the device; and
searching the database for the battery pack identification information by using the device identification information received from the device, generating evaluation information for the battery pack by using the battery data information and the battery pack information about the battery pack mapped to the battery pack identification information, and storing evaluation information for the battery pack in the database.

11. A server comprising:
a communication device; and
a processor configured to execute a computer program that performs the operating method of a server that performs a life-cycle assessment on a battery set forth in claim 1.

12. A method of providing a service of performing a life-cycle assessment on a battery by using a battery management system including a battery pack manufacturer's computing device, a device manufacturer's computing device, and a server, the method comprising:
in a battery pack manufacturing operation, receiving, by a server, battery pack information including battery pack identification information of a battery pack from a battery pack manufacturer's computing device and storing, by the server, the battery pack information in a database;
in an operation of mounting the battery pack on a device, receiving, by the server, the battery pack identification information and device identification information about the device on which the battery pack is mounted, from a device manufacturer's computing device;
one-to-one mapping, by the server, the device identification information to the battery pack identification information received from the device manufacturer's computing device and storing, by the server, the mapped information in the database;
in the operating operation of the device, as the battery pack supplies power to the device, receiving, by the server, the device identification information and battery data information about the battery pack from the device; and
searching, by the server, the database for the battery pack identification information by using the device identification information received from the device, generating, by the server, evaluation information for the battery pack by using the battery data information and the battery pack information about the battery pack mapped to the battery pack identification information, and storing, by the server, the evaluation information for the battery pack in the database.

13. The method of claim 12, wherein,
when the battery pack comprises a plurality of battery cells, evaluation information for the battery pack comprises residual value information of each of the battery cells.

14. The method of claim 12, further comprising:
when the battery management system further comprises a computing device, receiving, by the server, an evaluation information transmission request including the battery pack identification information or the device identification information, from the computing device;
searching, by the server, the database for the evaluation information for the battery pack by using the battery pack identification information or the device identification information included in the evaluation information transmission request; and
transmitting, by the server, the evaluation information for the battery pack to the computing device.

15. An operating method of a server that performs a life-cycle assessment on a battery, the operating method comprising:
in a battery pack manufacturing operation, receiving, by the server, battery pack information including battery pack identification information about a battery pack from a battery pack manufacturer's computing device and storing, by the server, the battery pack information in a database;
in an operation of mounting the battery pack on an electric car, receiving, by the server, the battery pack identification information, and electric car identification information about the electric car on which the battery pack is mounted, from an electric car manufacturer's computing device;
one-to-one mapping, by the server, the electric car identification information to the battery pack identification information received from the electric car manufacturer's computing device and storing, by the server, the mapped information in the database;
receiving, by the server, user information including user identification information about a user of the electric car, and the electric car identification information, from a user's computing device;
one-to-one mapping, by the server, the user identification information received from the user computing device to any one of the battery pack identification information and the electric car identification information and storing the mapped information in the database;
in a driving operation of the electric car, as the battery pack supplies power to the electric car, receiving, by the server, the electric car identification information and battery data information about the battery pack, from the electric car; and
searching, by the server, the database for the battery pack identification information by using the electric car identification information received from the electric car, generating, by the server, evaluation information for the battery pack by using the battery data information and the battery pack information about the battery pack mapped to the battery pack identification information, and storing, by the server, the evaluation information for the battery pack in the database.

16. The operating method of claim 15, further comprising:
receiving, by the server, the electric car identification information, and electric car data information generated by the electric car as power of the battery pack is supplied to the electric car, from the electric car; and
analyzing, by the server, a driving pattern of the user based on the electric car data information and generating user evaluation information corresponding to an analysis result; and
searching, by the server, the database for the battery pack identification information by using the electric car identification information received from the electric car, and generating the evaluation information for the battery pack by using the battery pack information about the battery pack mapped to the battery pack identification information, the battery data information, and the user evaluation information.

17. The operating method of claim 16, further comprising:
receiving, by the server, a user evaluation information transmission request from the user computing device; and
transmitting, by the server, the user evaluation information to the user computing device in response to the user evaluation information transmission request.

18. The operating method of claim 15, further comprising:
in an operation of charging the battery pack mounted on the electric car through a battery charging device connected to the electric car, receiving, by the server, the user identification information and charge information from the battery charging device; and
searching, by the server, the database for the battery pack identification information by using the user identification information received from the battery charging device, and
generating, by the server, charge data information about the battery pack according to the charge information,
wherein the charge data information comprises a charge number for each charge/discharge type.

19. The operating method of claim 15, further comprising:
receiving, by the server, an evaluation information transmission request including the battery pack identification information or the electric car identification information, from a computing device;
searching, by the server, the database for the evaluation information for the battery pack by using the battery pack identification information or the electric car identification information included in the evaluation information transmission request; and
transmitting, by the server, the evaluation information for the battery pack to the computing device.

20. The operating method of claim 19, wherein,
when the battery pack comprises a plurality of battery cells, evaluation information for the battery pack comprises residual value information of each of the battery cells.

21. A storage medium storing a computer program that performs an operating method of a server that performs a life-cycle assessment on a battery, wherein the computer program performs:
in a battery pack manufacturing operation, receiving battery pack information including battery pack identification information about a battery pack from a battery pack manufacturer's computing device and storing the battery pack information in a database;
in an operation of mounting the battery pack on an electric car, receiving the battery pack Identification information, and electric car identification information about the electric car on which the battery pack is mounted, from an electric car manufacturer's computing device;
one-to-one mapping the electric car identification information to the battery pack identification information received from the electric car manufacturer's computing device and storing the mapped information in the database;
receiving user information including user identification information about a user of the electric car, and the electric car identification information, from a user's computing device;
one-to-one mapping the user identification information received from the user computing device to any one of the battery pack identification information and the electric car identification information and storing the mapped information in the database;
in a driving operation of the electric car, as the battery pack supplies power to the electric car, receiving the electric car identification information and battery data information about the battery pack, from the electric car; and
searching the database for the battery pack identification information by using the electric car identification information received from the electric car, generating evaluation information for the battery pack by using the battery data information and the battery pack information about the battery pack mapped to the battery pack identification information, and storing the evaluation information for the battery pack in the database.

22. A computer program combined with hardware and stored in a storage medium to perform an operating method of a server that performs a life-cycle assessment on a battery,
wherein the computer program stored in the storage medium performs:
in a battery pack manufacturing operation, receiving battery pack information including battery pack identification information about a battery pack from a battery pack manufacturer's computing device and storing the battery pack information in a database;
in an operation of mounting the battery pack on an electric car, receiving the battery pack identification information, and electric car identification information about the electric car on which the battery pack is mounted, from an electric car manufacturer's computing device;
one-to-one mapping the electric car identification information to the battery pack identification information received from the electric car manufacturer's computing device and storing the mapped information in the database;
receiving user information including user identification information about a user of the electric car, and the electric car identification information, from a user's computing device;
one-to-one mapping the user identification information received from the user computing device to any one of the battery pack identification information and the electric car identification information and storing the mapped information in the database;
in a driving operation of the electric car, as the battery pack supplies power to the electric car, receiving the electric car identification information and battery data information about the battery pack, from the electric car; and
searching the database for the battery pack identification information by using the electric car identification information received from the electric car, generating evaluation information for the battery pack by using the battery data information and the battery pack information about the battery pack mapped to the battery pack identification information, and storing the evaluation information for the battery pack in the database.

23. A server comprising:
a communication device; and
a processor configured to execute a computer program that performs the operating method of a server that performs a life-cycle assessment on a battery set forth in claim 15.

24. A method of providing a service of performing a life-cycle assessment on a battery by using a battery management system including a battery pack manufacturer's computing device, a device manufacturer's computing device, and a server, the method comprising:
in a battery pack manufacturing operation, receiving, by the server, battery pack information including battery pack identification information about a battery pack from a battery pack manufacturer's computing device and storing, by the server, the battery pack information in a database;
in an operation of mounting the battery pack on an electric car, receiving, by the server, the battery pack identification information, and electric car identification information about the electric car on which the battery pack is mounted, from an electric car manufacturer's computing device;
one-to-one mapping, by the server, the electric car identification information to the battery pack identification information received from the electric car manufacturer's computing device and storing, by the server, the mapped information in the database;
receiving, by the server, user information including user identification information about a user of the electric car, and the electric car identification information, from a user's computing device;
one-to-one mapping, by the server, the user identification information received from the user computing device to any one of the battery pack identification information and the electric car identification information and storing the mapped information in the database;
in a driving operation of the electric car, as the battery pack supplies power to the electric car, receiving, by the server, the electric car identification information and battery data information about the battery pack, from the electric car; and
searching, by the server, the database for the battery pack identification information by using the electric car identification information received from the electric car, generating, by the server, evaluation information for the battery pack by using the battery data information and the battery pack information about the battery pack mapped to the battery pack identification information, and storing, by the server, the evaluation information for the battery pack in the database.

25. The method of claim 24, wherein,
when the battery pack comprises a plurality of battery cells, evaluation information for the battery pack comprises residual value information of each of the battery cells.

26. The method of claim 25, further comprising:
when the battery management system further comprises a computing device, receiving, by the server, an evaluation information transmission request including the battery pack identification information or the electric car identification information, from the computing device receive;
searching, by the server, the database for the evaluation information for the battery pack by using the battery pack identification information or the electric car identification information included in the evaluation information transmission request; and
transmitting, by the server, the evaluation information for the battery pack to the computing device.
